(19) United States
(12) Patent Application Publication
(10) Pub. No.: US 2026/0018963 A1
(43) Pub. Date: Jan. 15, 2026

(54) VERTICAL MOUNT FOR A CIM-STYLE MOTOR

(71) Applicant: Nandini Aastha Khaneja, North Hills, NY (US)

(72) Inventor: Nandini Aastha Khaneja, North Hills, NY (US)

(21) Appl. No.: 19/270,538

(22) Filed: Jul. 16, 2025

(51) Int. Cl. H02K 5/22

(52) U.S. Cl. CPC H02K 5/225

(57) ABSTRACT

A device that orients a motor with a rotating shaft on one end and wires on the other such that the rotating shaft faces upwards and the wires are routed out of the device through a lower chamber and a hole on its side while also being able to be mounted to a surface opposite the rotating shaft end.

### FIELD

The present application relates to a housing for a CIM-style motor in which the rotating shaft faces upwards, the wires are routed through the side, and can be attached to a surface below.

### BACKGROUND

CIM-style motors are often mounted horizontally when used in robotics competitions. Typically, the power is used to operate a chain or belt system to move a mechanism up or down. However, in other applications unrelated to these competitions, this is not ideal and is ineffective when the mechanism must rotate in the x and z planes. Some systems that attempt to solve this challenge use brackets that screw into holes in the motor's body, but when also utilizing a gearbox, these systems lack stability. Others keep this vertical orientation but attach to other components from the side, such that the wires needed to power the motor do not break; however, these systems are not useful where there are no parallel rails to attach the motor.

### SUMMARY

The Vertical Mount for a CIM-Style Motor houses the motor upright and routes the wires beneath through a lower chamber and out of the mount while allowing the motor to be mounted securely to a surface below the device.

### BRIEF DESCRIPTION OF DRAWINGS

The upper chamber is a cylinder slightly wider than the diameter of the motor, with a hole at the bottom for the wires. The wires are routed through this hole and through another hole at the side of the lower chamber. At the base of the lower chamber and around the middle of the full setup, two holes for bolts or other attachment devices are at opposite sides of the device.

FIG. 1 shows a front view of the device.

FIG. 2 shows a front-top corner view of the device.

FIG. 3 shows a back view of the device.

FIG. 4 shows a top view of the device.

FIG. 5 shows a bottom view of the device.

### DETAILED DESCRIPTION

In the following detailed description, the motor housed by this device is referred to as a CIM-style motor. However, this device is applicable to the housing of any other type of motor with a rotating shaft on one end and wires on another.

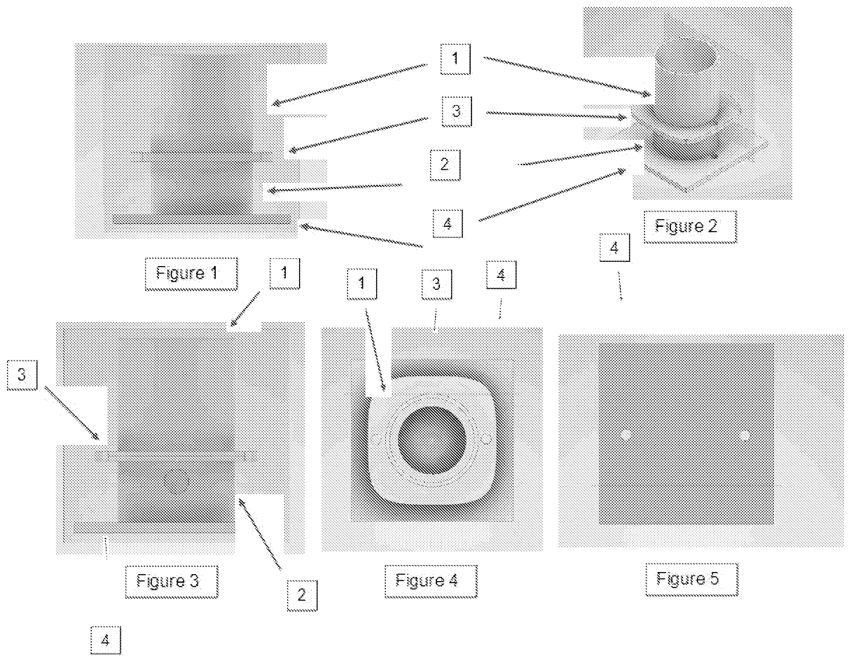

A front view of the device is shown in FIG. 1. The upper rectangle (1) is the upper chamber and the lower rectangle (2) is the lower chamber. The middle rectangle (3) is used to hold the item used to attach the device to another surface. The thin bottom rectangle (4) is the base of the device.

A front-top corner view of the device is shown in FIG. 2. The holes in 3 and 4 are for the bolts or other item used to attach the device to another surface to pass through. The edges of 3 are rounded for safety, minimizing the risk of the operator scraping themself on the metal.

A back view of the device is shown in FIG. 3. The hole in 2 is the place from which the wires are routed out of the device for attachment to a power source, motor controller, or other device to operate the motor electronically.

A top view of the device is shown in FIG. 4. The hole in the center of 3 is the place from which the wires cross from the upper chamber to the lower chamber. It should be noted that the body of the motor is primarily held within the upper chamber and supported from the sides of the cylinder. The holes to the sides of 3 are for the bolts or other item used to attach the device to another surface to pass through

A bottom view of the device is shown in FIG. 5. The holes in 4 are for the bolts or other item used to attach the device to another surface to pass through.

This device is fabricated from aluminum or other durable material such that extended use does not wear away the housing ability of the device. The device need not be fabricated using CNC manufacturing, as sheet metal fabrication has been used with success. It is recommended that the diameter of 1 and 2 be slightly wider than the width of the motor used such that epoxy or hardening liquids or putties can be used to seal in the motor and allow for the motor to fit despite manufacturing issues. If gaps are seen between 1 and 2, 2 and 3, or 3 and 4, it is recommended to fill gaps as needed with hardening putty for additional strength.

1. A device that houses a motor that on one end has a rotating shaft and on the opposite end has wires, orienting it such that the rotating shaft faces upward and the device is mounted to a surface on the opposite end, allowing the wires to be routed through a hole into a lower chamber of the device and out of it through another hole in its side.
